(19) United States
(12) Patent Application Publication
(10) Pub. No.: US 2009/0031118 A1
(43) Pub. Date: Jan. 29, 2009

(54) Apparatus and method for controlling order of instruction

(75) Inventor: Yusuke Kobayashi, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Corporation, Tokyo (JP)

(21) Appl. No.: 12/213,098

(22) Filed: Jun. 13, 2008

(30) Foreign Application Priority Data
Jul. 24, 2007 (JP) 2007-191621

(51) Int. Cl. G06F 9/312

(52) U.S. Cl. 712/225; 712/E09.033

(57) ABSTRACT

An apparatus includes an instruction generator which generates a load instruction and a first store instruction from a program, a processor which executes said load and store instruction, wherein said instruction generator analyzes a relevancy between said load instruction and said first store instruction with respect to memory addresses accessed by said instructions, specifies a second store instruction irrelevant to said load instruction with respect to said memory address, and notifies said second store instruction to said processor, wherein said processor executes said load instruction in advance of said second store instruction during said processor prepares to execute said second store instruction.

### INCORPORATION BY REFERENCE

This application is based upon and claims the benefit of priority from Japanese patent application No. 2007-191621, filed on Jul. 24, 2007, the disclosure of which is incorporated herein in its entirety by reference.

### BACKGROUND OF THE INVENTION

1. Field of the Invention

The present invention relates to arithmetic processing techniques, and in particular, relates to the arithmetic processing technique that improves the process performance in accessing a main memory.

2. Description of Related Art

In recent years, the calculation performance of a CPU of an information processing device has increasingly improved by having a large number of computing units mounted thereon. In particular, recently, the number of systems using a coprocessor that supports the calculation for improving the calculation performance in the CPU has been increasing. The system using such coprocessor has a SIMD (Single Instruction Multiple Data) type computing unit mounted thereon as the coprocessor, and thus employs a technique for executing calculation with a small number of instructions to improve the calculation performance. Patent Document 1 and the like, for example, are known as the technique for improving the process performance with such a coprocessor.

While the calculation performance of a CPU has been improving significantly, there is also presented a technique for reducing the access time to a main memory.

For example, Patent Document 2 discloses a scheduling method related to the dependency between a store instruction and a load instruction. The invention of Patent Document 2 describes a technique, in which, while the instruction for calculating a store address and the instruction for calculating a load address are handled in distinction from each other, the address dependency (the presence or absence of redundant addresses in a main memory) between the load address and the store address is checked to change the order of the instructions in execution of the instruction for calculating the load address. According to the invention of Patent Document 2, the instruction throughput can be increased by scheduling the instruction calculation in relation to the main memory. In addition, such scheduling technique related to the dependency between a store address and a load address is also known in Patent Document 3.

[Patent Document 1] Japanese Patent Application Publication No. 2006-048661

[Patent Document 2] Japanese Patent Translation Publication No. 2002-527798

[Patent Document 3] Japanese Patent Application Publication No. 2006-228241

Meanwhile, although such techniques have been presented, there has been no noticeable improvement in performance in terms of the reduction in memory access time, which a CPU takes to access a main memory (main memory). Thus, there is a problem in that the high process performance of a CPU cannot be utilized sufficiently. This has the following background.

As for the memory access technique, when an instruction sequence executed by a CPU includes a plurality of load instructions, a plurality of operation instructions using the loaded data, and a plurality of store instructions for storing the calculation, the central processing section of the CPU checks the address dependency between the load instructions and the store instructions. Here, checking the address dependency is checking whether or not the address in a main memory serving as the write destination address of a store instruction (hereinafter, also referred to as a store address) coincides with the address in the main memory serving as the read destination address of a load instruction (hereinafter, also referred to as a load address). In this case, a “pending” of the process required for the check will occur in the CPU. Namely, until the above-described address dependency check is completed, the subsequent load instruction cannot be read from the main memory prior to the store instruction, and as shown in FIG. 8, the CPU side cannot process the subsequent load instruction prior to the store instruction. For this reason, the subsequent load instruction has to wait until the store address is determined through the execution of the store instruction. Furthermore, the arithmetic processing (denoted as FAD in FIG. 8) following the load instruction also has to wait until the load instruction is completed, and hence the so-called “pending” will occur.

Even if the performance of the algorithm of a CPU itself is improved, the process performance associated with the memory access cannot be improved significantly. This is because there is such “pending” due to the address dependency check, so that readout of a load instruction from the main memory becomes a bottleneck in the improvement.

For example, even a high-speed CPU, which includes a coprocessor and also secures a sufficient bandwidth of a transmission line to the main memory, requires address dependency check in reading a load instruction from a main memory. Accordingly, the number of load instructions which can be read at once from the main memory is limited, and the readout process of a load instruction becomes a bottleneck. In other words, the capability of a high spec CPU has been under utilized, resulting in a waste of the hardware resource.

Thus, the “pending” at the time of this address dependency check is difficult to dissolve even with the related art including the inventions of Patent Document 2 and Patent Document 3 described above.

Additionally, a CPU provided with such a coprocessor has another problem if the addresses used in a load instruction and a store instruction are stored in the resource (register) inside the coprocessor, in particular.

For example, when a CPU is provided with a coprocessor which, after the value of the resource (register or the like) in its own processor is determined, sends the value of the register to the central processing section, the “pending” in the CPU will occurs. Accordingly, it is difficult for the CPU to check the address dependency while efficiently executing a memory access instruction, on which the result of the register in the coprocessor is reflected.

### SUMMARY OF THE INVENTION

According to one exemplary aspect of the present invention, an apparatus, includes: an instruction generator which generates a load instruction and a first store instruction from a program, and a processor which executes the load and store instruction, wherein the instruction generator analyzes a relevancy between the load instruction and the first store instruction with respect to memory addresses accessed by the instructions, specifies a second store instruction irrelevant to the load instruction with respect to the memory address, and notifies the second store instruction to the processor, wherein the processor executes the load instruction in advance of the second store instruction during the processor prepares to execute the second store instruction.

According to another exemplary aspect of the present invention, a method, includes: generating a load instruction and a first store instruction from a program, the instructions are executed by a processor, analyzing a relevancy between the load instruction and the first store instruction with respect to memory addresses accessed by the instructions, specifying a second store instruction irrelevant to the load instruction with respect to the memory address, notifying the second store instruction to the processor, executing the load instruction in advance of the second store instruction during the processor prepares to execute the second store instruction.

### BRIEF DESCRIPTION OF THE DRAWINGS

Other exemplary aspects and advantages of the invention will be made more apparent by the following detailed description and the accompanying drawings, wherein:

FIG. 1 is a block diagram of a first exemplary embodiment in an arithmetic processing unit;

FIG. 2 is a block diagram showing a configuration of an address dependency determining section;

FIG. 3 is a configuration of a decoder section and an instruction buffer section of the address dependency determining section;

FIG. 4 is a configuration of a determination circuit of the address dependency determining section;

FIG. 5 is a configuration of a determination circuit of the address dependency determining section;

FIG. 6 is an exemplary instruction sequence executed by the present invention;

FIG. 7 is a flow of compile processes corresponding to the respective program types in a compiler;

FIG. 8 is a exemplary processing instructions associated with the related art;

FIG. 9 is an exemplary processing instructions associated with memory access in the present invention;

FIG. 10 is a diagram of a second exemplary embodiment of the present invention.

### DETAILED DESCRIPTION OF THE EXEMPLARY EMBODIMENTS

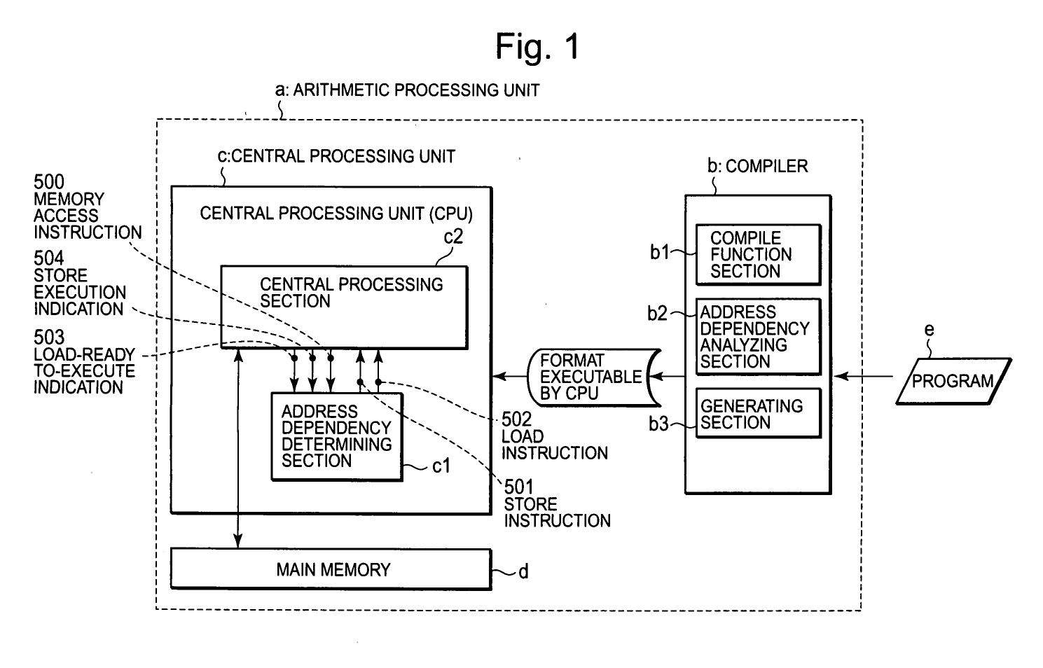

A first exemplary embodiment of the present invention is described using a block diagram shown in FIG. 1.

FIG. 1 is the whole view of an arithmetic processing unit of the present invention.

As shown in FIG. 1, reference numeral a represents an arithmetic processing unit of the present invention, including: a compiler b having a function for compiling; a central processing unit c (CPU) ; and a main memory d. Reference numeral e represents a program inputted to the compiler b. The program e may be written in a high-level language, such as C, or may be written in assembly language for an assembler or the like.

First, the configuration of the compiler b is described.

The compiler b not only has a function, which, upon input of the program e, converts this into a form (object code) executable by the CPU, but also analyzes the content of the program e and notifies the analysis result to the CPU.

Specifically, the compiler b includes a compile function section b1, an address dependency analyzing section b2 and a generating section b3.

The compile function section b1 converts the inputted program e into a form (object code) executable by the CPU.

The address dependency analyzing section b2 analyzes the address dependency within the program e. Specifically, based on the presence or absence of duplication between the write destination address in the main memory of a store instruction and the read destination address in the main memory of a load instruction, the address dependency of a group of instructions consisting of a plurality of store instructions and a plurality of load instructions is determined to identify a load instruction without the address dependency on the store instruction.

Here, the address dependency indicates a state whether or not the address of a load instruction in the main memory (also referred to as a load address or a main memory load address) and the address of a store instruction in the main memory (also referred to as a store address or a main memory store address) are duplicating. The load instruction is a memory access instruction used in reading a value from a storage location of the main memory in response to an address, and is sometimes referred to as a main memory load instruction. The store instruction is a memory access instruction used in writing to a storage location of the main memory in response to an address, and is sometimes referred to as a main memory store instruction.

Based on the analysis in the address dependency analyzing section b2, the generating section b3 adds to a plurality of store instructions having no address dependency, among the received group of instructions, an identification information indicating that there is no address dependency. Furthermore, an end position information indicative of an end position of the group of instructions whose dependency is already determined is also added. Then, the generating section b3 sends this group of instructions to the central processing unit. Then, the generating section b3 adds these information to a corresponding instruction sequence in a group of instructions (object code) converted by the compile function section b1, and notifies this to the central processing unit.

Specifically, based on the analysis in the address dependency analyzing section b2, the generating section b3 generates an NST instruction (identification information) and an OEND instruction (end position information), and adds these to a corresponding instruction sequence in the object code, and notifies this to the central processing unit. Here, the NST instruction is an identification information for identifying a store instruction having no address dependency on the load instruction. The OEND instruction is information indicative of an end position of a group of instructions whose address dependencies are already determined. The execution of analysis on the address dependency can be neglected until reaching the position indicated by this information. This OEND instruction is used on the central processing unit side as the end position information used for preferentially sending a load instruction following a store instruction that was identified with the NST instruction.

The central processing unit c is a CPU having the function to process a group of instructions including an instruction sequence, to which the NST instruction or the OEND instruction notified from the compiler b is added, in addition to the function to execute general instruction sequences.

Next, the configuration of the central processing unit c is described.

As shown in FIG. 1, the central processing unit c includes an address dependency determining section c1 and a central processing section c2.

The address dependency determining section c1 determines the presence or absence of address dependency based on the NST instruction and the OEND instruction generated by the compiler b. The determination of the presence or absence of this address dependency is carried out using a flag corresponding to the NST instruction and the OEND instruction, while the address dependency check based on comparison between addresses is not carried out during this time. Specifically, the address dependency determining section c1, upon receipt of the NST instruction, determines that a plurality of load instructions following a plurality of store instructions identified by the NST instruction may be sent prior to the plurality of store instructions identified by the NST instruction.

Namely, upon receipt of the NST instruction, the address dependency determining section c1, until a store instruction to which the NST instruction is added is ready to execute, sends a load instruction located before the OEND instruction prior to the store instruction with the NST instruction being added, and then causes the central processing section c2 to execute the load instruction. Such a series of process may be referred to as “prior-execution of a plurality of load instructions” herein.

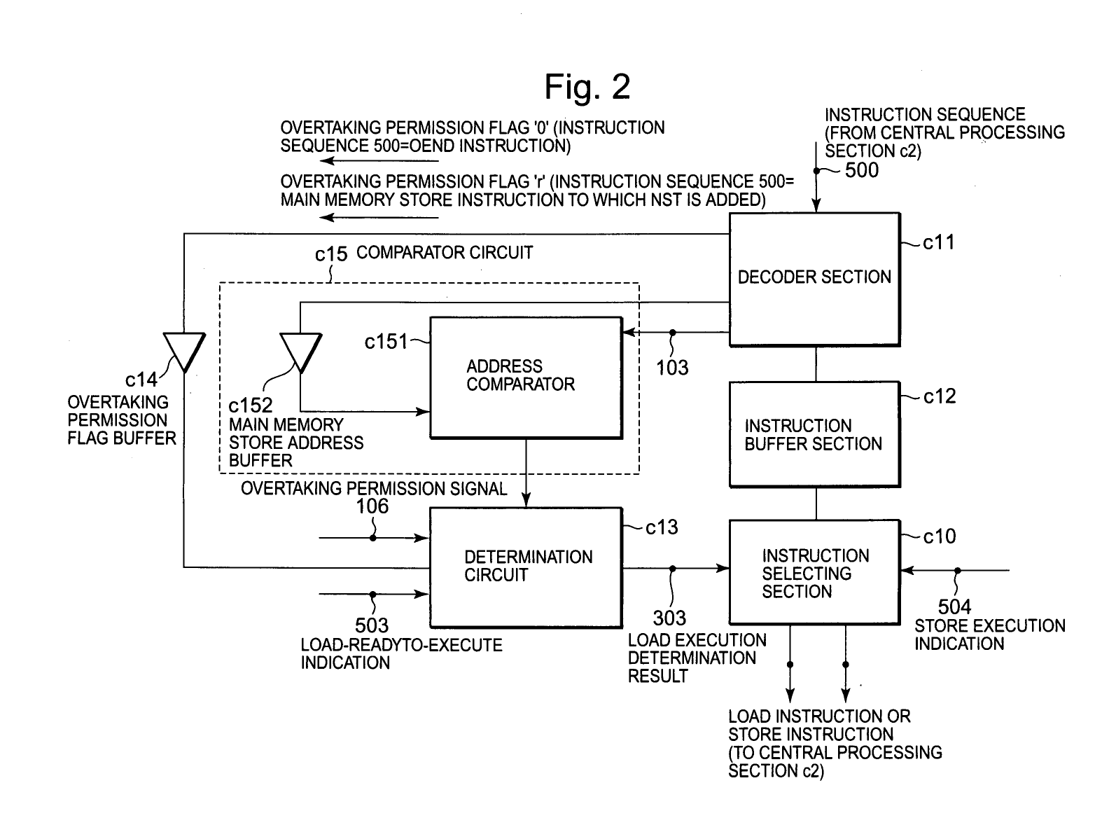

Then, the configuration of the address dependency determining section c1 is described using FIG. 2.

As shown in FIG. 2, the address dependency determining section c1 includes: a decoder section c11 decoding an instruction sequence; an instruction buffer section c12 that stores this decoded instruction sequence for each instruction type; a determination circuit c13 that determines the presence or absence of address dependency based on the NST instruction and OEND instruction and that determines whether or not to allow a load instruction to be executed prior to a store instruction; an instruction selecting section c10 that selects an instruction sequence outputted from the instruction buffer section c12 based on the determination result by the determination circuit c13; an overtaking permission flag buffer c14 for managing a store instruction that allows for the overtaking of an instruction; and a comparator circuit c15 for checking the address dependency.

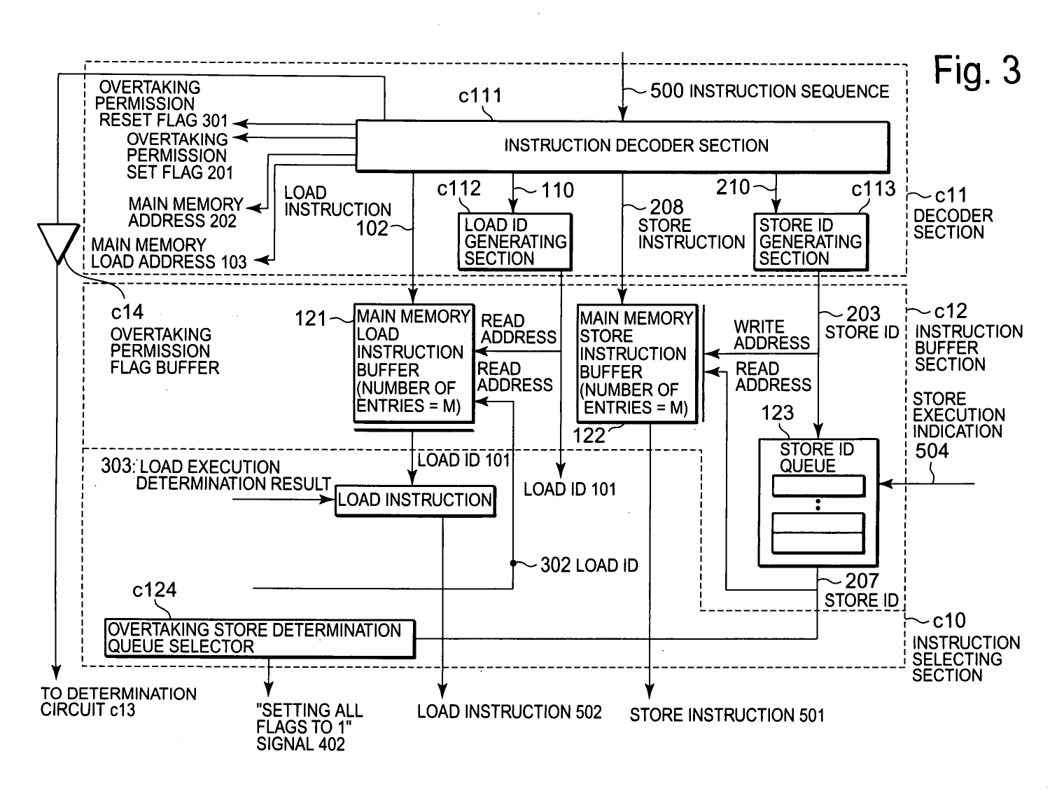

First, specific configurations of the decoder section c11, the instruction buffer section c12, and the instruction selecting section c10 will be described in detail using block diagrams of FIG. 2 and FIG. 3.

As shown in FIG. 3, the decoder section c11 includes an instruction decoder section c111 decoding the instruction type of a received instruction sequence, a load ID generating section c112, and a store ID generating section c113.

The instruction decoder section c111 decodes the instruction type of each instruction sequence (instruction sequence 500) of a received group of instructions, and stores this decoded instruction into the instruction buffer section c12 for each instruction type. Moreover, the instruction decoder section c111, upon receipt of a store instruction including the NST instruction, sends an overtaking permission set flag ‘1’ to the overtaking permission flag buffer c14. Furthermore, the instruction decoder section c111, upon receipt of the OEND instruction, sends an overtaking permission reset flag ‘0’ to the overtaking permission flag buffer c14.

If an instruction received in the instruction decoder section c111 is a load instruction, the load ID generating section c112 generates a load ID which is information for identifying this instruction. This load ID generating section c112 is actually a grant counter or the like.

When an instruction received in the instruction decoder section c111 is a store instruction, the store ID generating section c113 also generates a store ID for identifying this instruction. The store ID generating section c113 is also a grant counter or the like.

Moreover, as shown in FIG. 3, the instruction buffer section c12 includes a main memory load instruction buffer section c121 for storing a main memory load instruction, a main memory store instruction buffer section c122 for storing a main memory store instruction, and a store ID queue c123.

In the main memory load instruction buffer section c121, the generated load ID and load instruction are associated with each other and stored.

In the main memory store instruction buffer section c122, the generated store ID and store instruction are associated with each other and stored.

In the store ID queue c123, the store ID generated in the store ID generating section c113 is stored. The store ID queue c123 outputs the store ID in response to a store execution indication 504 from the central processing section c2 of the central processing unit. Here, the store execution indication 504 is a signal indicative of completion of a store instruction without address dependency. In this exemplary embodiment, when the central processing section c2 confirmed that the hardware resource for executing a store instruction has been secured and the arithmetic processing is completed on the central processing section c2 side, the central processing section c2 will send this store execution indication 504. This store execution indication 504 may be notified upon completion of the arithmetic processing in the central processing section c2, without waiting for the securing of hardware resource to be confirmed.

An instruction selecting section c10 selects, based on a determination result by the determination circuit c13, an instruction sent to the central processing section c2 from the main memory load instruction buffer section c121 and main memory store instruction buffer section c122 of the instruction buffer section c12.

Next, the configuration of the determination circuit c13 shown in FIG. 2 is described.

This determination circuit c13 determines the presence or absence of address dependency based on a signal received from the decoder section c11 through the overtaking permission flag buffer c14. Specifically, the determination circuit c13 first receives an overtaking permission signal 106 indicating whether or not to allow for the overtaking. This overtaking permission signal 106 is a signal indicative of either state of an “overtaking set flag ‘1’” or an “overtaking permission reset flag ‘0’” received from the instruction decoder section c1111. Then, when the value of the overtaking permission flag of this overtaking permission signal 106 is ‘1’, the determination circuit c13 determines that the decoder section c11 has received a “store instruction including the NST instruction”, i.e., a store instruction without address dependency.

Furthermore, when it is determined from the conditions or the like of the hardware resource that the load is ready to execute, the determination circuit c13 receives a load-ready-to-execute indication 503 from the CPU.

The determination circuit c13, in response to the received overtaking permission signal 106 and the load-ready-to-execute indication 503, outputs to the instruction selecting section c10 a load execution determination result 303 allowing for execution of the load instruction.

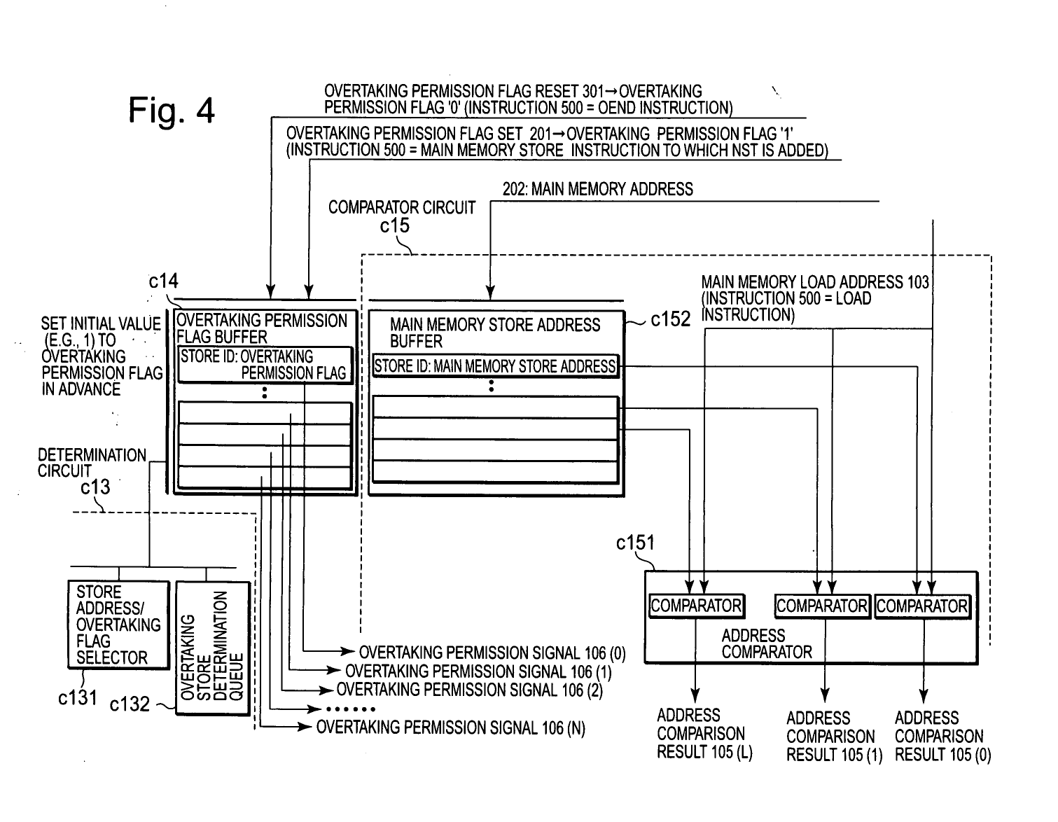

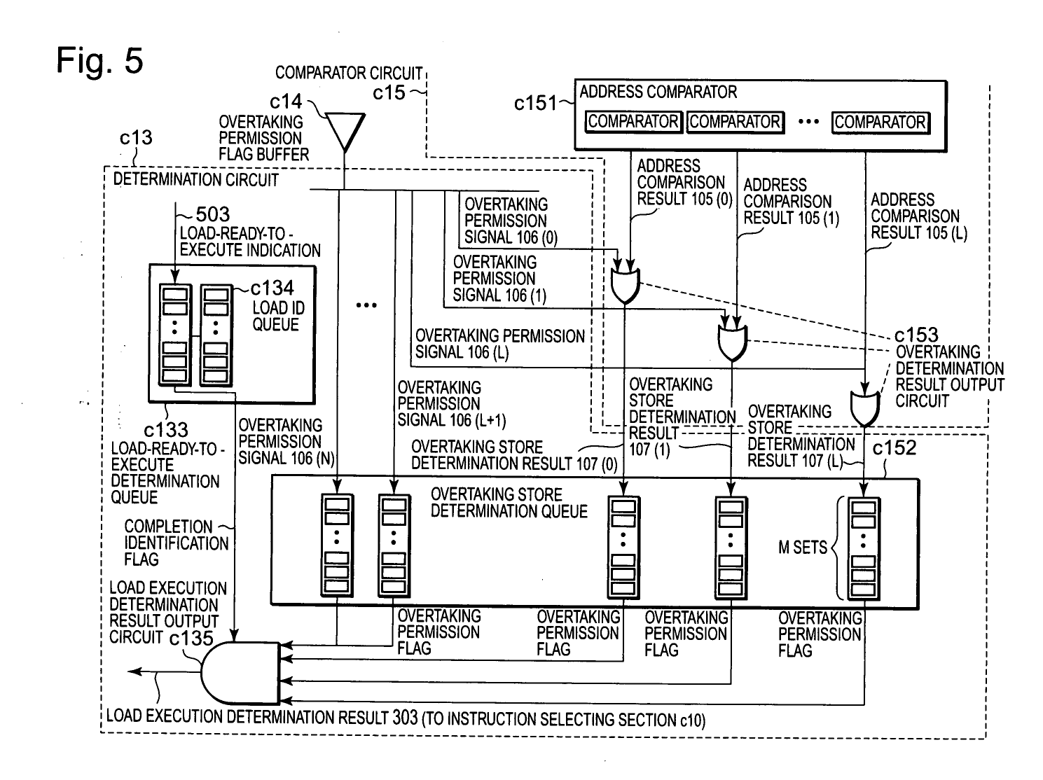

FIG. 4 and FIG. 5 show, the detailed configurations of the determination circuit c13.

As shown in FIG. 4 and FIG. 5, the determination circuit c13 is coupled with the overtaking permission flag buffer c14, and includes a store address/overtaking flag selector c131, and an overtaking determination queue 132, a load-ready-to-execute determination queue 133, a load ID queue c134, and a load execution determination result output circuit c135 shown in FIG. 5.

The overtaking permission flag buffer c14 is a buffer for associating and storing the store ID notified from the decoder section c11 with the value of the overtaking permission flag notified from the decoder section c11. The initial value ‘1’ is set to this overtaking permission flag buffer c14 in advance.

After a store instruction to which the NST instruction is added is outputted, the store address/overtaking flag selector c131 shown in FIG. 4 resets to ‘0’ the value of the flag of the overtaking permission flag buffer corresponding to the store ID of this store instruction.

The overtaking determination queue c132 shown in FIG. 5 is a queue used in determining whether or not a load instruction following a store instruction corresponding to the store ID may be executed prior to this store instruction. The overtaking determination queue 132 is configured with N FIFO (First in First Out) type queues (N: natural number), and each of these N queues is provided corresponding to a store ID. Furthermore, M entries (M: natural number) are provided in each queue. Namely, the overtaking permission signal 106 (‘0’ or ‘1’) or the overtaking store determination result 107 (‘0’ or ‘1’) from the overtaking permission flag buffer c14 will be stored in a queue corresponding to the store ID.

The load-ready-to-execute determination queue c133 shown in FIG. 5 is a queue used in determining whether or not a load instruction is ready to execute in the central processing section c12. When the load-ready-to-execute determination queue c133 receives from the central processing section c2 the load-ready-to-execute indication 503 indicating whether or not a load instruction is ready to execute, the completion identification flag (0 or 1) based on this load-ready-to-execute indication 503 is associated with the load ID and stored therein. Here, as the completion identification flag indicating that a load instruction is ready to execute on the central processing section c12 side, ‘1’ is used.

The load execution determination result output circuit c135 is an AND gate, i.e., a circuit that calculates the logical product of the value of the “overtaking permission flag (‘0’ or ‘1’)” outputted from the overtaking determination queue 132 and the “completion identification flag (‘0’ or ‘1’)” outputted from the load-ready-to-execute determination queue c133. The load execution determination result output circuit c135 notifies the instruction selecting section c10 of the calculation result of the logical product calculated here as the load execution determination result.

Then, the internal configuration of the comparator circuit c15 is described using FIG. 4 and FIG. 5.

The comparator circuit c15 is a circuit used when an instruction sequence outside the scope of the analysis on address dependency is received. Namely, the comparator circuit c15 is used in analyzing the address dependency on the subsequent load instruction upon receipt of a general store instruction, to which the NST instruction is not added, located after an end position where the OEND instruction is added.

The comparator circuit c15 includes an address comparator c151, a main memory store address buffer c152 for storing the main memory store address of a store instruction, and an overtaking determination result output circuit 153 (FIG. 5) which is an OR gate.

The main memory store address buffer c152 is a buffer used for storing the main memory store address of a store instruction. The store ID and the main memory store address are associated with each other and stored.

The address comparator c151 is configured with L comparators. A main memory load address is stored in each of these L comparators. Each comparator compares a main memory store address received from the main memory store address buffer c152 with a main memory load address received from the instruction decoder section c11 to output an address comparison result 105. Namely, each comparator outputs ‘1’ when these addresses do not coincide with each other as a result of the comparison, and outputs ‘0’ when these addresses coincide with each other.

The overtaking determination result output circuit c153 shown in FIG. 5 is an OR gate. Namely, the overtaking determination result output circuit c153 is a circuit for calculating the logical sum of the value of the “address comparison result 105 (‘0’ or ‘1’)” outputted from each comparator of the address comparator c151 and the “overtaking permission signal 106 (‘0’ or ‘1’)” outputted from the overtaking permission flag buffer of the determination circuit c16. This calculation result is outputted to the overtaking determination queue c132 of the determination circuit c16 as the “overtaking store determination result 107.”

Next, the operation in the first exemplary embodiment is described in detail using FIG. 1 to FIG. 6.

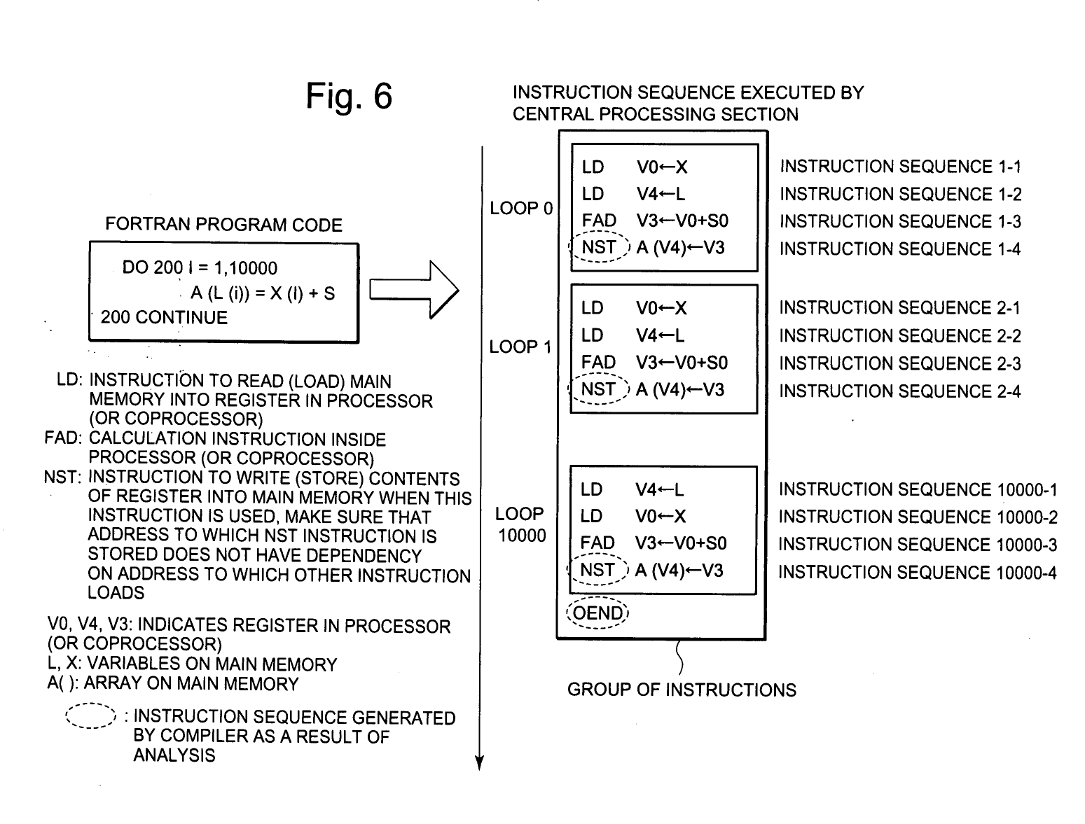

In addition, hereinafter, assume that the code of a FORTRAN program shown in an example on the left of FIG. 6 has been converted by the compiler b to an instruction sequence (an instruction sequence 1-1 to an instruction sequence 10000-4) shown in an example on the right of FIG. 6. Then, the description is made assuming that the instruction sequence shown in the example of FIG. 6 is sequentially read by the central processing unit c.

Moreover, although a counting loop process shown in FIG. 6 will be described hereinafter as a process example of the program, other program content may be the object of processing.

Moreover, although, description is made assuming that the program is a program written in FORTRAN herein, programs written in other languages, such as C, may be the object of processing.

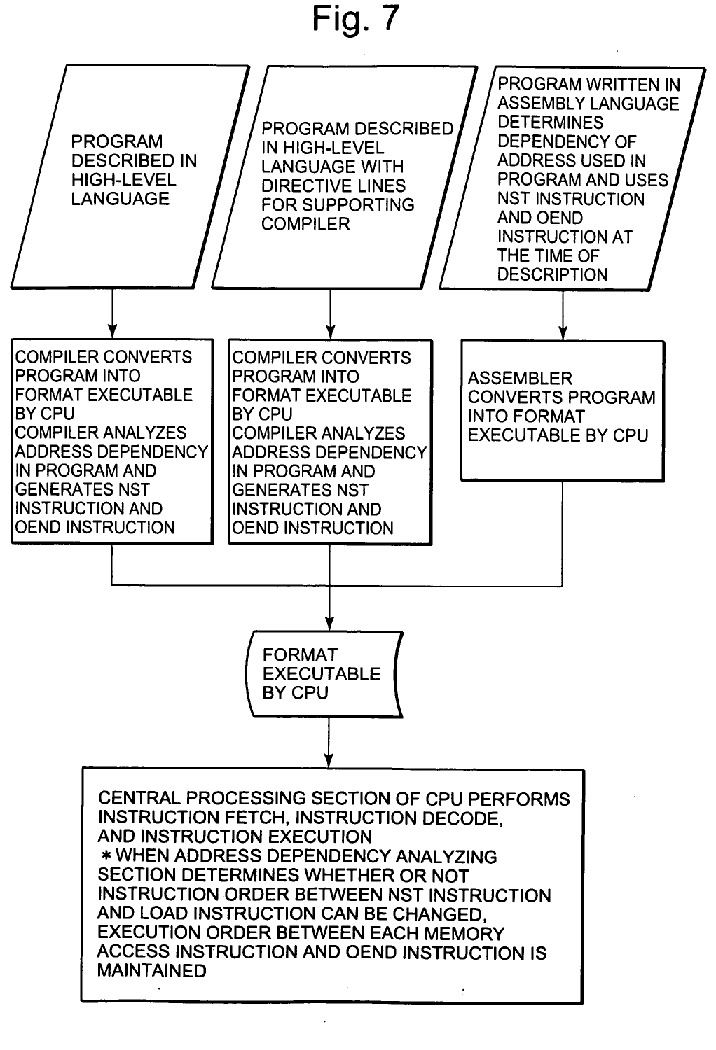

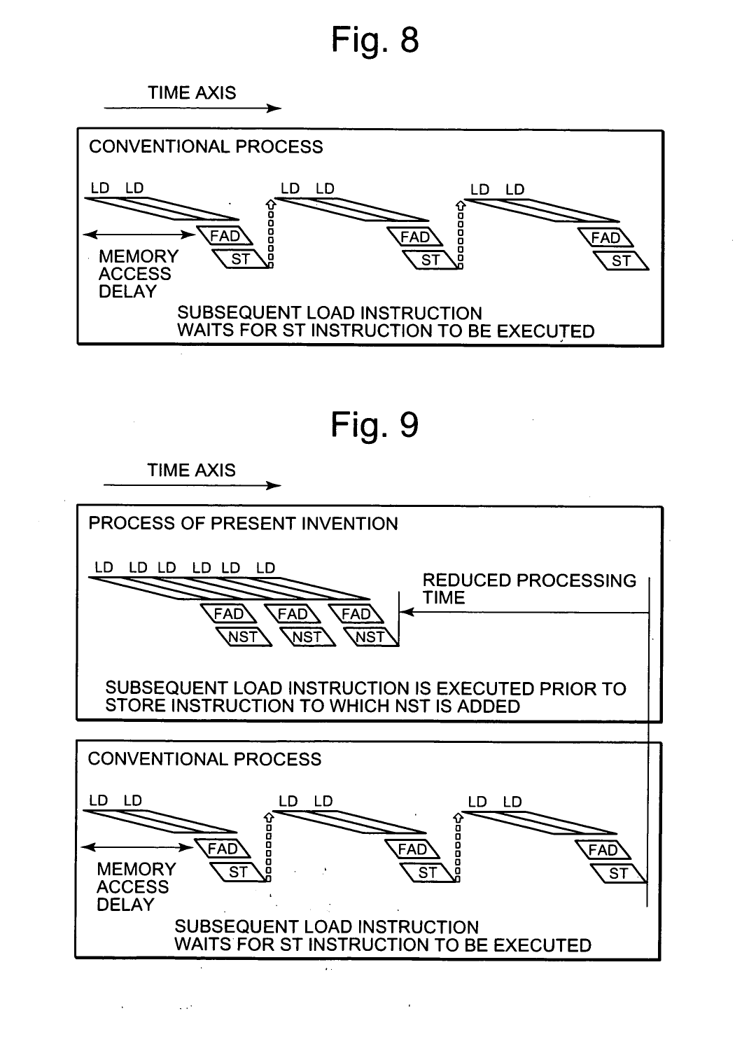

Moreover, although herein, FORTRAN, which is high level language, is described as an example of the program, a program written in any assembly language may be converted by an assembler. In this case, a programmer may manually add the NST instruction and the OEND instruction, taking into account the address dependency in the program. FIG. 7 shows a schematic flow of compile processes corresponding to the types of these programs.

Moreover, hereinafter, the description is made assuming that the final position of a group of instructions in the target region, where the address dependency has been analyzed, is the end position and the OEND instruction is added, but not limited thereto. The end position may be determined in such a manner that the number of load instructions may be a constant number of instructions and that the OEND instruction may be added, taking into account the hardware resource, such as the throughput of the central processing unit and the capacity of the main memory load instruction buffer section.

Now, as shown in FIG. 2, if the address dependency determining section c1 receives the instruction sequence 500 from the central processing section c2, the decoder section c11 will determine the instruction type of the received instruction sequence 500. Here, the instruction sequence 500 corresponds to the instruction sequence 1-1 of FIG. 6, and is determined as a load instruction by the instruction decoder section c111 of the decoder section c11.

Next, as shown in FIG. 3, the instruction decoder section c111 sends a loading-ID grant counter count-up signal 110 to the load ID generating section c112. Here, the loading-ID grant counter count-up signal 110 is a signal for incrementing the counter value of the load ID generating section c112. The load ID generating section c112 that received the loading-ID grant counter count-up signal 110 generates a load ID 101(1-1) corresponding to the received load instruction. Then, the load instruction is associated with the load ID (1-1) and stored in the main memory load instruction buffer section 121. Moreover, the load ID 101(1-1) is also sent to the load ID queue c134.

Subsequently, the main memory load address of the load instruction corresponding to the load ID 101(1-1) is sent to the address comparator c151 of the comparator circuit c15.

Here, as shown in FIG. 4, in the comparator c151, the main memory store address received from the main memory store address buffer c152 is compared with the main memory load address received from the instruction decoder section c11 to output the address comparison result 105. Here, there is no entry of the main memory store address and the addresses does not coincide with each other, so that the address comparison result 105 is outputted as ‘0’.

Next, as shown in FIG. 5, the overtaking determination result output circuit 153 calculates the logical sum of the value (here, ‘0’) of the “address comparison result 105” outputted from the address comparator c151 and the “overtaking permission signal 106” outputted from the overtaking permission flag buffer c161 of the determination circuit c16. Here, the initial value ‘1’ is currently set to all the entries of the overtaking permission flag buffer c14. For this reason, the address comparison (address dependency analysis) by the comparator circuit c15 will not be carried out. This is because all of an “overtaking store determination result 107(0) to an overtaking store determination result 107(N)”, which are the calculation results of the logical sum by the overtaking determination result output circuit 153, will be outputted as ‘1’ regardless of the comparison results of the comparator circuit c15. Namely, the calculation result by the overtaking determination result output circuit 153 becomes ‘1’. This “overtaking store determination result ‘1’ is notified to the overtaking determination queue c132, and all values of the “overtaking permission flags” outputted from N queues of the overtaking store determination queue 132 become ‘1’.

Then, when a load instruction is ready to execute in the central processing section c2, the central processing section c2 sends the load-ready-to-execute indication 503 to the load execution preparation determination queue c133 of the address dependency determining section c1. Here, the completion identification flag ‘1’ corresponding to the load ID 101(1-1) is sent to the load execution determination result output circuit c135 as the load-ready-to-execute indication 503. This completion identification flag ‘1’ is sent to the load execution determination result output circuit c135 along with the load ID 101(1-1).

Subsequently, the load execution determination result output circuit c135 calculates the logical product of the value (here, ‘1’) of the “overtaking store determination result” outputted from each overtaking store determination queue 132 and the “value (here, ‘1’) of the “completion identification flag” outputted from the load-ready-to-execute determination queue 133. Here, the load execution determination result ‘1’ is notified to the instruction selecting section c10. At this time, along with the load execution determination result ‘1’, the load ID 101(1-1) is also notified to the instruction selecting section c10.

Next, as shown in FIG. 3, the instruction selecting section c10 that received the load ID 101(1-1) and the load execution determination result 303 ‘1’ instructs the main memory load instruction buffer section c121 of the instruction buffer section c12 to output a load instruction 502(1-1) corresponding to the load ID 101(1-1). Then, the load instruction 502(1-1) is outputted. This outputted load instruction 502(1-1) is passed to the central processing section c2. Thus, the load instruction 502 corresponding to the instruction sequence 1-1 is processed in the central processing section c2. Namely, a value “X” is read from a V0 register.

In a similar manner, a load instruction corresponding to an instruction sequence 1-2 shown in FIG. 6 is processed in the central processing section c2. Namely, a value “L” is read from a V4 register.

Subsequently, in the central processing section c2, an addition operation (FAD V3<−V0+S0) corresponding to an instruction sequence 1-3 shown in FIG. 6 is carried out. Note that this operation is not a memory access instruction but an arithmetic processing closed within the processor. Accordingly, an instruction sequence to be received next in the decoder section c11 is an instruction sequence 1-4 shown in FIG. 6.

Next, description will be given for explaining the operation in the case where a store instruction to which the NST instruction is added is received.

The decoder section c11 of the address dependency determining section c1 that received the instruction sequence 500 corresponding to the instruction sequence 1-4 shown in FIG. 6 will determine that the received instruction sequence 500 is a store instruction including the NST instruction.

Then, the instruction decoder section c111 shown in FIG. 3 sends to the store ID generating section c113 a storing-ID grant counter count-up signal 210. The store ID generating section c113 that received the storing-ID grant counter count-up signal 210 will generate a store ID 203(1-4) corresponding to the received store instruction. The generated store ID 203(1-4) is stored in the store ID queue c123. Moreover, a store instruction 208(1-4) corresponding to the store ID 203(1-4) is associated with the main memory address corresponding to the store ID 203(1-4) and stored in the main memory store instruction buffer section 122.

At this time, as shown in FIG. 4, the main memory store address 202(1-4) of the store instruction corresponding to the store ID 203(1-4) is sent to the main memory store address buffer c152 shown in FIG. 4. Then, in the main memory store address buffer c152, the store ID 203(1-4) and the main memory store address corresponding to the store ID 203(1-4) are associated with each other and stored.

Here, the instruction decoder section c11 that determined that the received instruction sequence 500 includes the NST instruction will send the overtaking permission flag set 201 “flag value ‘1’” and the store ID 203(1-4) to the overtaking permission flag buffer c14.

As shown in FIG. 4, in the overtaking permission flag buffer c14, the store ID (here, store ID 203(1-4)) and the overtaking permission flag (here, the overtaking permission flag ‘1’) are associated with each other and stored. Furthermore, this overtaking permission flag ‘1’ is sent to the queue corresponding to the store ID 203(1-4) of the overtaking store determination queue 132 shown in FIG. 5 and is stored therein.

In addition, the store instruction 208(1-4) stored in the main memory store instruction buffer section 122 shown in FIG. 3 will not be outputted to the central processing section c2 until the arithmetic processing (FIG. 6: addition operation corresponding to the instruction sequence 1-3) in the central processing section c2 is completed.

Incidentally, here, if the instruction decoder section c111 further receives the subsequent instruction sequence (FIG. 6: instruction sequence 2-1), the subsequent instruction sequence is determined as a load instruction and a load ID 101(2-1) is generated. This load instruction is also associated with the load ID 101(2-1) and stored in the main memory load instruction buffer section c121.

Then, if the load instruction is ready to execute in the central processing section c2 shown in FIG. 1, the central processing section c2 sends the load-ready-to-execute indication 503 to the address dependency determining section c1. Also here, upon receipt of the load-ready-to-execute indication 503, the completion identification flag ‘1’ corresponding to the load ID 101(2-1) is sent to the load execution determination result output circuit c135. This completion identification flag ‘1’ is sent to the load execution determination result output circuit c135 along with the load ID 101(2-1). Also at this time, the load execution determination result of the load execution determination result output circuit c135 is ‘1’. The instruction selecting section c10 that received this load execution determination result ‘1’ will output a load instruction 502(2-1) corresponding to the load ID 101(2-1).

Thereafter, in a similar manner, the subsequent load instructions (FIG. 6: instruction sequence 2-2, . . . , 10000-1, 10000-2) are sequentially outputted without having to wait.

Here, when the arithmetic processing (FIG. 5: addition operation corresponding to the instruction sequence 1-3) in the central processing section c2 is completed, a store instruction (instruction sequence 1-4) to which the NST instruction is added will be outputted from the address dependency determining section c1 to the central processing section c2. The specific operation thereof is as follows.

First, when the arithmetic processing of the instruction sequence 1-3 is completed in the central processing section c2, the address dependency determining section c1 will receive the store execution preparation indication 504 from the central processing section c2. Specifically, as shown in FIG. 3, the store ID queue c123 receives the store execution preparation indication 504. The store ID queue c123 in response to the store execution preparation 504 will output a store ID 207(1-4). This store ID 207(1-4) is sent to the main memory store instruction buffer section c122. Then, the instruction selecting section c10 outputs a store instruction 501(1-4) corresponding to the store ID 207(1-4) from the main memory store instruction buffer section c122.

Upon output of the store instruction 501(1-4), as shown in FIG. 3, the store ID 207(1-4) is also sent to the overtaking store determination queue selector c124. Here, in response to the output of the store instruction 501(1-4), the overtaking store determination queue selector c124 sends a “setting ALL flags to 1” signal 402 to the overtaking store determination queue c132 corresponding to the store ID 207(1-4). ‘1’ is set to all the entries in the overtaking determination queue that received the “setting ALL flags to 1” signal 402. By setting ‘1’ this way, “pending” will not occur in the subsequent load instructions. Furthermore, the store address/overtaking flag selector c131 of FIG. 4 will reset the flag of the overtaking permission flag buffer c14 corresponding to the received store ID 207 to ‘0’, and reset the valid flag of the main memory store address buffer c152 corresponding to the received store ID 207 to ‘0’.

Similarly, upon completion of the next arithmetic processing (instruction sequence 2-3) in the central processing section c2, the next store instruction (instruction sequence 2-4) to which the NST instruction is added will be also outputted by the instruction selecting section c10. Hereinafter, similarly, upon completion of the subsequent arithmetic processing (FIG. 6: instruction sequence 3-3, . . . , 10000-3), the store instruction (instruction sequence 3-4, . . . , 10000-4) to which the NST instruction is added will be also outputted.

Subsequently, description will be given for explaining the operation in the case where the OEND instruction is received.

Upon determination that the received instruction sequence 500 is the OEND instruction, the decoder section c11 of the address dependency determining section c1 holds the store instruction and load instruction including the NST instruction following the OEND instruction for at least one cycle, and sends an overtaking permission flag reset 301 ‘0’ to the overtaking permission flag buffer c14. All the flags of the overtaking permission flag buffer c14 are reset to ‘0’ by the sent overtaking permission flag reset 301. This enables the address comparison (address dependency analysis) by the comparator circuit c15.

After this, the address dependency check process by comparison of the address of a store instruction with the address of a load instruction is carried out by the comparator circuit c15. Namely, the address dependency check by the comparator circuit c15 is resumed. Here is the reason why the address dependency check is resumed. Upon receipt of the OEND instruction, the flag of the overtaking permission flag buffer c14 is set to ‘0’. Consequently, when a subsequent instruction sequence is received, the overtaking store determination result 107, which is obtained as the result of the logical sum operation performed by the overtaking determination result output circuit c153, depends on the value of the flag of the address comparison result 105 obtained by the comparator circuit c15.

In this way, as shown in FIG. 9, a prior output of a load instruction without address dependency on the store instruction is executed.

In the above-described first exemplary embodiment, by carrying out the address dependency check to a group of instructions consisting of a plurality of store instructions and a plurality of load instructions, a load instruction without address dependency can be identified and this identified load instruction can be executed prior to the store instruction. Thus, as compared with the related art, more load instructions can be executed preferentially and the process associated with access to the main memory can be speeded up.

Moreover, until reaching the end position of a group of instructions each of which address dependency is already determined, the central processing unit side does not need to carry out address dependency check by comparison between their addresses, so that the pending of a load instruction and the pending of the arithmetic processing following the load instruction will be dissolved, and thus the efficiency of the arithmetic processing can be improved.

Moreover, a situation can be avoided in which the buffers required when a load instruction waits for a store instruction to be executed and for the store address to be determined run short inside the central processing unit and thus the instruction pipeline becomes a busy state.

Moreover, it is possible to suppress the occurrence of the “pending” state even in processing a group of instructions having such many instructions that the number of store instructions exceeds the number (L) of comparators. Here is the reason why. In the conventional configuration, if the number of store instructions exceeds the number (L) of comparators, the address dependency cannot be checked and thus the “pending” occurs, while in the present invention, in preferentially processing a load instruction following a plurality of store instruction to which the NST instruction is added, the address dependency check by comparison between their addresses will not be carried out and thus the limitation due to the number of comparators will disappear.

Moreover, the number of comparators can be made smaller than the number of store instructions, so that the hardware resource will be eventually saved and the device cost can be suppressed.

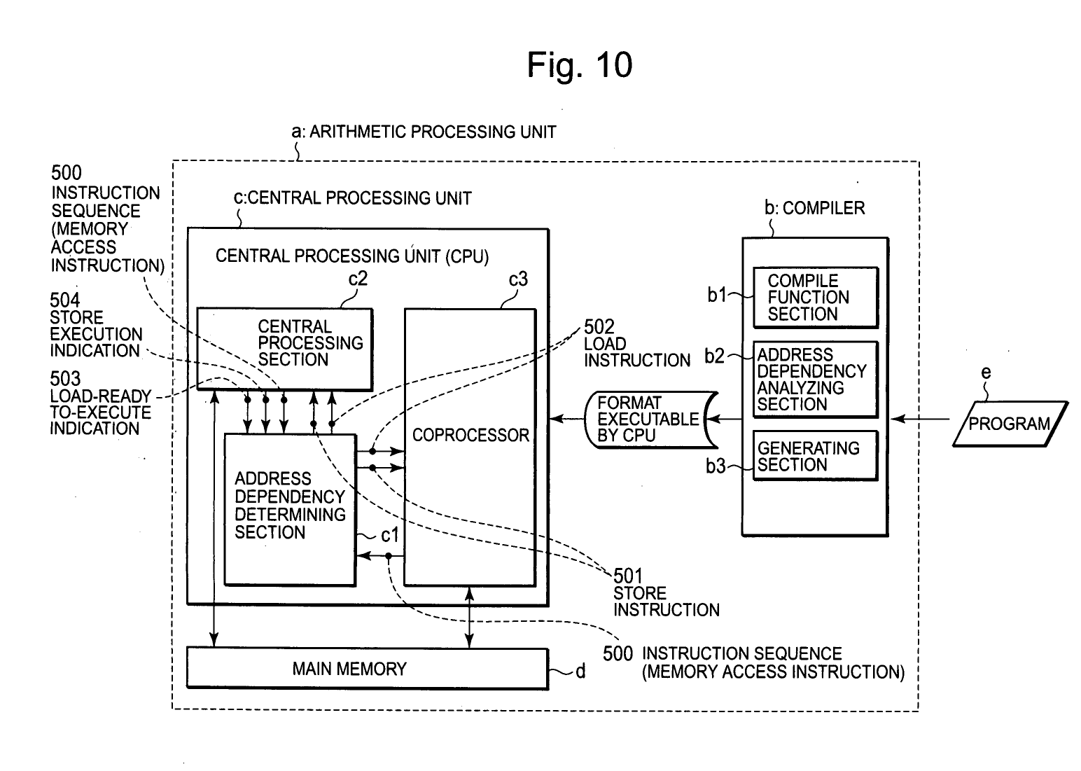

Next, a second exemplary embodiment is described using FIG. 10.

As shown in FIG. 10, in the configuration of the second exemplary embodiment, the central processing unit c includes a coprocessor c3 compared to the first exemplary embodiment.

In sending the load instruction 502 and the store instruction 501 to the central processing section c2, the address dependency determining section c1 of the central processing unit c in the second exemplary embodiment sends these instructions also to the coprocessor c3.

Moreover, in the central processing unit c in the second exemplary embodiment, an instruction sequence can be also executed in the central coprocessor c3.

Note that the processing operation of the instruction sequence is the same as in the description made in the first exemplary embodiment, so that the detailed description is omitted here.

In the above-described second exemplary embodiment, the central processing unit c includes the address dependency determining section c1 operating in cooperation with the coprocessor. For this reason, even if the coprocessor is implemented in its own unit, the central processing unit can preferentially execute a load instruction following a store instruction including the NST instruction without checking the address dependency within the region indicated by the OEND instruction and thus can improve the processing efficiency of the memory access instruction.

According to the present invention, the process performance of the arithmetic processing unit can be improved. This is because, in the present invention, by executing the address dependency check to a group of instructions consisting of a plurality of store instructions and a plurality of load instructions, a load instruction without the address dependency can be identified and this identified load instruction can be executed prior to the store instruction. Accordingly, as compared with the related art, more load instructions can be preferentially executed and the high speed process associated with access to the memory can be achieved.

What is claimed is:

1. An apparatus, comprising:
an instruction generator which generates a load instruction and a first store instruction from a program; and
a processor which executes said load and store instruction;
wherein said instruction generator analyzes a relevancy between said load instruction and said first store instruction with respect to memory addresses accessed by said instructions, specifies a second store instruction irrelevant to said load instruction with respect to said memory address, and notifies said second store instruction to said processor;
wherein said processor executes said load instruction in advance of said second store instruction during said processor prepares to execute said second store instruction.

2. The apparatus according to claim 1, wherein said processor further comprises:
a control unit which controls an order of execution of said instructions; and
an execution unit which executes said instructions based on said order;
wherein said control unit controls said order so that said load instruction are executed in advance of said second store instruction during said execution unit prepares to execute said second store instruction.

3. The apparatus according to claim 2, wherein said control unit further comprises:
a decode unit which sets a permission flag when said decode unit receives said second store instruction, said permission flag indicating whether said load instruction following said second store instruction is permissible to be executed in advance of said second store instruction;
a determination circuit which generates a determination signal indicating that said load instruction following said second store instruction is to be executed when said permission flag is set; and
a selecting unit which selects said load instruction so that said load instruction is executed by said execution unit when said selecting unit receives said determination signal.

4. The apparatus according to claim 3, wherein said decode unit resets said permission flag when said decode unit receives said first store instruction not specified as said second store instruction.

5. The apparatus according to claim 3, wherein said selecting unit selects said load instruction except when said selecting unit receives a store execution signal from said execution unit, said store execution signal indicating that said second store instruction is ready for execution.

6. The apparatus according to claim 3, wherein said instruction generator generates a plurality of said load instructions and said first store instructions;
wherein said determination circuit further comprises:
a plurality of first buffers which store said permission flag, each of said first buffers corresponding to each of said first store instructions and said second store instruction;
a second buffer which stores load execution signals sent from said execution unit, said load execution signal indicating that said load instruction is ready for execution, each of said load execution signals corresponding to each of said load instructions; and
a determination result output unit which outputs said determination signals based on said permission flag and said load execution signals, each of said determination signals corresponding to each of said load instructions.

7. The apparatus according to claim 6, wherein said permission flags stored in said first buffers are set when said processor is initialized.

8. The apparatus according to claim 6, wherein said determination result output unit outputs said determination signal indicating that said load instructions following said second store instruction are to be suspended when at least one of said first buffers stores said permission flag not being set.

9. The apparatus according to claim 3, wherein said selecting unit further comprises:
a flag setting unit which sets said permission flag stored in said first buffer when said selecting unit selects said first store instruction or said second store instruction, said permission flag corresponding to said store instruction being selected.

10. The apparatus according to claim 2, wherein said control unit further comprises:
a comparator which compares said load instructions and said store instructions with respect to said memory addresses when said control unit receives said store instructions not being specified as said second store instruction.

11. A method, comprising:
generating a load instruction and a first store instruction from a program, said instructions are executed by a processor; and
analyzing a relevancy between said load instruction and said first store instruction with respect to memory addresses accessed by said instructions;
specifying a second store instruction irrelevant to said load instruction with respect to said memory address;
notifying said second store instruction-to said processor;
executing said load instruction in advance of said second store instruction during said processor prepares to execute said second store instruction.

12. The method according to claim 11, further comprises:
controlling an order of execution of said instructions;
executing said instructions based on said order;
wherein said controlling step said order is controlled so that said load instruction are executed in advance of said second store instruction during said execution unit prepares to execute said second store instruction.

13. The method according to claim 12, further comprises:
setting a permission flag upon receiving said second store instruction, said permission flag indicating whether said load instruction following said second store instruction are permissible to be executed in advance of said second store instruction;
generating a determination signal indicating that said load instruction following said second store instruction is to be executed when said permission flag is set; and
selecting said load instructions upon receiving said determination signal, so that said load instruction is executed by said processor.

14. The method according to claim 13, further comprises:
resetting said permission flag upon receiving said store instruction not specified as said second store instruction.

15. The method according to claim 13, further comprises:
selecting said load instruction until receiving a store execution signal indicating that said second store instruction is ready for execution.

16. The method according to claim 13, further comprises:
generating a plurality of said load instructions and said first store instructions;
storing said permission flag in a plurality of first buffers, each of said first buffers corresponding to each of said first store instructions and said second store instruction;
storing load execution signals sent from said execution unit in a second buffer, said load execution signal indicating that said load instruction is ready for execution, each of said load execution signals corresponding to each of said load instructions; and
outputting said determination signals based on said permission flag and said load execution signals, each of said determination signals corresponding to each of said load instructions.

17. The method according to claim 16, further comprises:
setting said permission flags stored in said first buffers when said processor is initialized.

18. The method according to claim 16, further comprises:
outputting said determination signal indicating that said load instructions following said second store instruction are to be suspended when at least one of said first buffers stores said permission flag not being set.

19. The method according to claim 13, further comprises:
setting said permission flag stored in said first buffer when said store instruction is selected, said first buffer corresponding to said first or second store instruction being selected.

20. The method according to claim 12, further comprises:
comparing said load instructions and said store instructions with respect to said memory addresses when said control unit receives said store instructions not being specified as said second store instruction.
